(19) United States
(12) Patent Application Publication
(10) Pub. No.: US 2007/0106584 A1
(43) Pub. Date: May 10, 2007

(54) SYSTEM AND METHOD FOR EDUCATING CONSUMERS ABOUT AVAILABLE LOW INTEREST FINANCING OPTIONS

(75) Inventor: Klee Irwin, Playa Del Rey, CA (US)

Correspondence Address: Greenberg Traurig, LLP, 12th Floor, 1750 Tysons Boulevard, McLean, VA, 22102, US

(73) Assignee: Near Zero, Inc., Los Angeles, CA (US)

(21) Appl. No.: 11/550,272

(22) Filed: Oct. 17, 2006

Related U.S. Application Data
(60) Provisional application No. 60/726,698, filed on Oct. 17, 2005.

(51) Int. Cl. G06Q 40/00

(52) U.S. Cl. 705/35

(57) ABSTRACT

A system and method for educating consumers about an available personal finance option, wherein a long-form infomercial is used to provide information about the personal finance option to consumers. If a consumer is interested in taking advantage of the personal finance option, the consumer can visit a web site, call a telephone number, or otherwise access additional information related thereto. Appropriate steps can be followed to facilitate the consumer's participation in the personal finance option. In an embodiment, the personal finance option can comprise a home equity line of credit, and may further comprise one or more credit cards associated with the home equity line of credit.

### PRIORITY CLAIM

This application is related to and claims the benefit of Provisional U.S. Patent Application Ser. No. 60/726,698 filed Oct. 17, 2005, which is incorporated herein by reference in its entirety.

### COPYRIGHT CLAIM

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The instant disclosure relates to the field of personal finance, and more particularly provides a system and method which utilizes at least one infomercial to educate consumers about how they can utilize home equity lines of credit as a basis for a secured credit card.

### BACKGROUND

Consumer spending drives much of the United States economy. From big ticket items, like homes and automobiles, to smaller items like meals at restaurants, clothing, and automobile repairs, consumer spending creates the demand that stimulates economic development.

Many consumer-oriented businesses recognize this fact, and allow the consumer to pay for goods or services after the consumer has received those goods or services. Examples of such consumer-oriented businesses include banks and other financial institutions, as well as private firms, such as department stores, home improvement stores, appliance and electronics stores, and the like. In many cases, the consumer's debt to the lender is paid within thirty or sixty days. In some cases, such as where the business offers a credit card, the consumer is able to finance this debt over a longer term. In the case of private firms who offer credit to consumers, the businesses benefit from this because, had they not extended credit to the customer, the sale may not have been made. Consumers also benefit, in that the business allows them to obtain the goods that best meet their needs and wants. In some instances, such as with a home loan, incurring debt is the only practical means for the consumer to purchase big-ticket items.

Where the good purchased is an appreciating asset, such as a home, or one that depreciates relatively slowly, like an automobile, many lenders are willing to extend credit at fairly low interest rates because the risk of actual financial loss is fairly low because the lender can always foreclose on and resell the good. However, where the goods purchased lose most of their value almost immediately, such as clothing, or where the goods or services are not tangible or exist only for a short time, such as plumbing repairs or restaurant-prepared meals, lenders are either not able to foreclose or the foreclosure value represents a significant loss. Thus, lenders are more reluctant to lend money for such purposes and they impose higher interest rates on those using the lender's money for such purposes. For example, because the credit available through credit cards can be used to purchase a variety of goods and services, credit card interest rates are typically at least 200% higher, and in many cases 400% to 500% higher, than most home or automobile loans.

While some consumers recognize the impact of carrying large amounts of debt at high interest rates, for some the higher interest rates are a necessary part of their lives. When health, career, or other issues impose financial hardships on people, some have no choice but to turn to credit cards or other higher-interest loans until they are able to get their lives in order. Unfortunately, this happens fairly frequently, and consumers in the United States have amassed fairly large debts.

As a result, although some consumers are able to carry little long-term debt, most consumers have at least one automobile loan, a home loan, and several credit cards, and recent news reports indicate that the average consumer's credit card balances are increasing. This increasing average consumer debt, and especially unsecured consumer debt, is an ongoing concern for many economists. Without a means to reduce their debt, more consumers are likely to declare bankruptcy. This can result in significant losses to businesses, and these losses can put jobs at risk. The job losses further increase the number of people who may turn to bankruptcy, and this feeds into an ever-increasing cycle. Furthermore, as the number of bankruptcies increases, banks and other financial institutions are more likely to require higher interest rates for both consumer and business loans, and this can further stifle economic growth.

Some in the prior art have attempted to market a home equity line of credit which includes a debit or credit card as a draw-down mechanism. In fact, financial experts agree that the most prudent way to finance one's personal debt is through home financing, which frequently provides the lowest interest rate available to most consumers. However, the companies in the prior art that have tried to market home equity loans and credit cards tied thereto have not been very successful in educating the public en mass about the advantages of such loans. As a result, the vast majority of American consumers do not use home loans to refinance their debt because they are uneducated as to this option.

Traditional consumer product commercials, such as those used by credit card companies, use entertaining, or some times shocking, content to attract the consumer's or listener's attention during the presentation. However, because of their short duration, these commercials are typically not able to inform consumers. Instead, consumer product commercials usually attempt to influence consumers by sheer redundancy. That is, the commercials repeat the same fundamental pieces of information, such as the current interest rate or a low introductory rate, several times during the commercial. The commercials are also shown or played multiple times during a typical day, in an effort to drive home their particular message.

While traditional consumer product commercials can be effective, if they are left in the advertising stream for too long their rote repetitiveness can erode and eventually decrease their effectiveness with the consuming public. Furthermore, running such advertisements can be cost prohibitive for many companies, especially those with products or services that are targeted toward consumers who may be experiencing financial difficulties, because such companies tend to operate on smaller profit margins.

In contrast to traditional commercials, infomercials can be scripted to educate consumers on pertinent issues and matters such as health care, real estate, and the like in one airing. The often academic presentation and nature of the content enable consumers to make an informed decision as to whether to buy a company's product or services based on personal needs or to those of family members. Infomercials also air much less frequently than traditional consumer product commercials, and thus can be less expensive than traditional consumer product commercials and do not suffer from the same repetitiveness issues as traditional commercials. Unfortunately for consumers, many financial services companies tend to view infomercials in a negative light. As a result, consumers are not made aware of the various products and services that are available that might significantly benefit the consumer.

An example of a product that might benefit consumers is the home equity line of credit, or HELOC. A HELOC allows a home owner to tap into the equity built up in his or her home, thereby giving the homeowner access to additional financial resources should they be necessary. Because the HELOC is backed by the equity in the home, most lenders consider these loans to be relatively secure, and thus do not charge interest rates as high as those associated with credit cards. Homeowners who have significant credit card or other high interest debt can take advantage of the lower HELOC rates to significantly reduce the amount of time necessary to get out of debt, or to reduce their overall monthly payments.

For those consumers aware of the HELOC option, one reason HELOC's have not become more popular as replacements for other types of loans is that most people feel that they need a credit card or other such “rapid access loan” in case of emergencies. Thus they are not willing to give up their credit cards, despite the higher interest rates associated with credit cards.

### SUMMARY

What is needed is a system and method through which financial services can be more readily marketed to individuals. More specifically, what is needed is a system and method through which individuals can receive information about low interest rate credit cards, and especially those tied to HELOC's, as well as other debt consolidation options. What is also needed is a system and method through which consumers can take advantage of debt consolidation options, such as low interest credit cards, without forgoing the ease of use and sense of comfort associated with traditional credit cards.

Accordingly, the instant disclosure is directed to a unique and non-obvious system and method of marketing, via long-form infomercial, home equity secured lines of credit that utilize a credit card, such as a Visa or Mastercard, as a draw down mechanism that substantially obviates one or more of the problems due to limitations and disadvantages of the related art. Such an infomercial may be presented to the consumers by radio, television, cellular telephone, theaters, personal digital assistants, portable audio and/or video players, online, or the like.

An object of the instant disclosure is to better inform consumers of debt consolidation options available to them.

Another object is to utilize a homeowner's home equity as the basis for a low interest loan that can be accessed in a manner similar to that associated with traditional credit cards.

Still another object is to market alternative personal finance options to consumers via infomercials.

Additional features and advantages will be set forth in the description which follows, and in part will be apparent from the description, or may be learned by practice of the disclosed system and methods. The objectives and other advantages of the invention will be realized and attained by the structure particularly pointed out in the written description and claims hereof.

The instant disclosure allows consumers who are homeowners to take advantage of the equity in their homes. The consumers can open a HELOC, and the HELOC can be used as a basis for a secured credit card. The advantage of a secured credit card is that, because the credit is secured by a lien on the homeowner's home, the financial institution underwriting the credit card is more likely to recover in the event the homeowner defaults on his or her debt. This reduced risk, in turn, means that the financial institution will not need to charge the high rates traditionally associated with credit cards. The interest rate associated with the HELOC-backed credit card can be further reduced by tying the interest rate to the amount the card is used on a monthly basis.

It is to be understood that both the foregoing general description and the following detailed description are exemplary and explanatory and are intended to provide further explanation of the invention.

### BRIEF DESCRIPTION OF THE FIGURES

FIG. 1 is a functional block diagram illustrating an architecture through which consumers can be educated about personal finance options and through which the consumers can take advantage of such options.

FIG. 2 is a flow diagram illustrating a method through which consumers can be educated about personal finance options and through which the consumers can take advantage of such options.

FIG. 3 is a functional block diagram of a system through which consumers can be educated about personal finance options and through which the consumers can take advantage of such options.

### DETAILED DESCRIPTION

Reference will now be made in detail to preferred embodiments of the instant disclosure, examples of which are illustrated in the accompanying drawings.

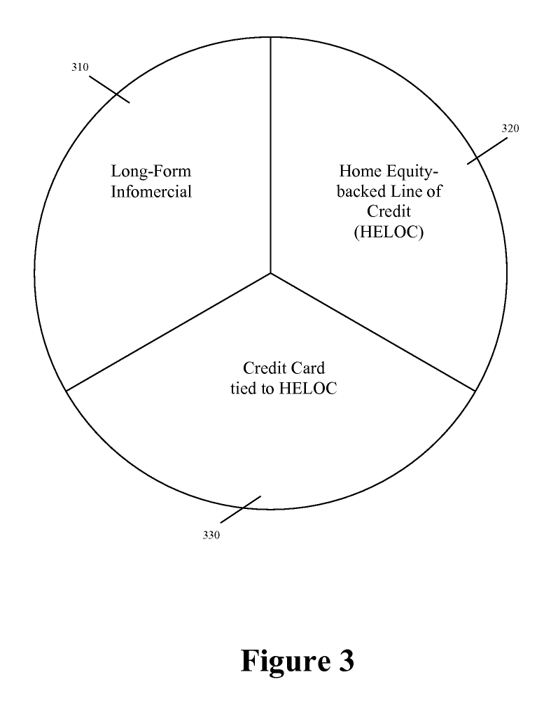

It takes at least 15 minutes of uninterrupted commercial time to explain the logic of moving all debt to a real estate secured line of credit that utilizes a credit card as a draw-down instrument. The only advertising vehicle that maintains an uninterrupted stretch like this is an infomercial. As such, and as illustrated in FIG. 3, an embodiment comprises three primary components: one or more infomercials 310, a HELOC 320, and a credit card tied to the HELOC 330. Each of these components will be described in more detail below.

As described above, infomercials 310 have proven to be an effective means for informing consumers about products or services from which the consumers might benefit. While infomercials have been used to sell a variety of products and services, infomercials have not been widely used in the personal finance space. As described above, there has been a long felt need for a means by which the public can be better informed about different debt consolidation and personal finance issues, and the instant disclosure allows businesses offering solutions to such issues to make the solutions known to the public. While the instant disclosure focuses on television infomercials, it should be apparent to one skilled in the art that alternative media and venues can be used to present the infomercials, including radio, cellular telephones, personal digital assistants, personal music players, the Internet, theaters and the like.

The second aspect, or component, of the instant disclosure is HELOC 320. As described above, HELOC's are typically tied to or secured by a homeowner's equity, and thus the issuing financial institution is able to offer the HELOC at a much lower interest rate than that associated with typical, non-secured loans such as credit cards. The instant disclosure is primarily oriented toward homeowners and, in part, allows them to utilize the HELOC to refinance their existing debt.

The third aspect of the instant disclosure is a credit card 330 tied to the HELOC. The credit card allows the consumer or other authorized individual to access funds from or secured by the HELOC. In some regards, the credit card aspect of the invention can be seen as functioning like a traditional secured credit card. However, unlike traditional secured credit cards which require a substantial cash deposit on the part of the consumer, the credit card of the instant disclosure is secured by the equity in the consumer's home. In other regards, the credit card aspect of the invention can be seen as functioning like an unsecured credit card, in that cash-back bonuses, frequent flier miles, or other incentives can be associated therewith.

In an embodiment, credit card 330 can include a plurality of actual credit cards that are tied to the HELOC. In this embodiment, the consumer can, for example, provide a credit card to each adult or mature family member. In addition to the overall credit limit associated with the HELOC, in one embodiment the consumer can set credit limits and/or monthly spending limits on each issued card, thereby preventing abuse. The consumer can also access detailed credit card statements online, thereby allowing the consumer to more easily track household spending. Monthly statements may also be provided as an option to the consumer. Examples of such other transactions include, without limitation, automobile loan payments, insurance premiums, medical bill payments, grocery purchases, gasoline purchases, utility bill payments, and the like.

By consolidating all purchases and other transactions through the HELOC-backed credit cards, the consumer can realize additional savings as well. By way of example, the interest rate associated with a HELOC-backed card may be reduced based on the amount purchased via the HELOC-backed credit card each month. It should be apparent to one skilled in the art that a multi-tiered interest rate structure may be implemented based on the amount financed each month, the interest rate may be calculated based on a percentage of the amount financed each month, and that other such interest rate structures can be substituted for those described herein without departing from the spirit or the scope of the invention. Similarly, although the credit card is tied to a HELOC and thus the lowest possible rate may be tied to home mortgage rates, the interest rate may be set independent of the home mortgage, where such an interest rate does not violate state or federal banking laws.

In one embodiment, the HELOC-issuer and/or the Infomercial producer may partner with a credit card issuer to issue co-branded credit cards tied to HELOCs. Such partners may participate with each other via a fee sharing arrangement for services performed in the manner and format in compliance with the State and Federal Regulatory Requirements. Such requirements may include, but are not limited to, those set forth by the U.S. Department of Housing and Urban Development, RESPA, Regulation Z and Regulation X and with those which govern Settlement Service Providers that may be applicable to the particular services rendered by the Company.

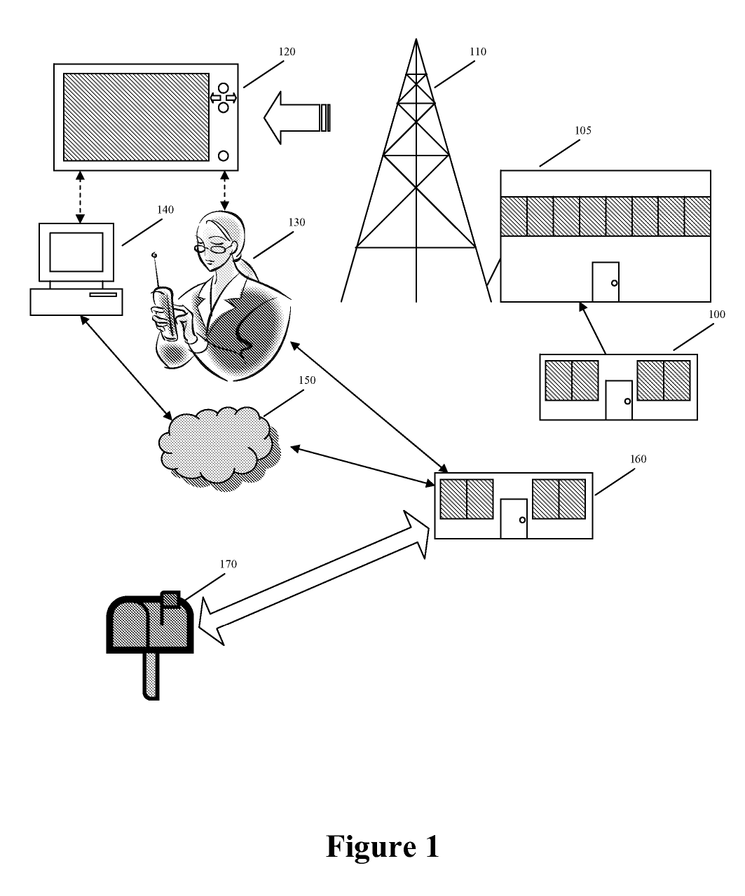

FIG. 1 is a functional block diagram illustrating an architecture through which consumers can be educated about personal finance options and through which the consumers can take advantage of such options. In FIG. 1, a HELOC-issuer, credit card issuer, or the like can contract with a television studio 100, a third party production studio, or the like to create an infomercial. The infomercial can contain information about credit cards, and especially low-interest credit cards, HELOCs, and/or other personal finance information. In an embodiment, the infomercial can include information about the advantages of HELOC-based credit cards, and how such credit cards can be used to ease a consumer's debt burden. Although the embodiments described herein make specific reference to television infomercials, alternative embodiments can include, without limitation, radio advertisements and Internet-based advertisements.

Once the infomercial has been created, it can be scheduled for broadcast by television station 105. Although illustrated as a station that broadcasts using conventional “over-the-air” techniques (including the use of tower 110), television station 105 may broadcast the infomercial using any video broadcasting technique including, without limitation, cable, satellite, digital over-the-air, digital cable, and digital broadband. In an embodiment, the infomercial may be provided by one or more web sites, and may be available on a Digital Versatile Disc (“DVD”) or video tape, thereby obviating the need to the consumer to be at their television set during the broadcast to see the infomercial.

Referring again to the embodiment illustrated in FIG. 1, the broadcast is received by an appropriate tuner or receiver associated with display 120, which presents the infomercial to consumer 130. Although display 120 is illustrated as a digital television set, it should be apparent that any form of display, including, without limitation, cathode ray tube (“CRT”) televisions, projection televisions, projectors, plasma televisions, liquid crystal display (“LCD”) televisions, digital light projection (“DLP”) televisions, computer monitors, and the like may be substituted therefor without departing from the spirit or the scope of the instant system.

When consumer 130 watches the infomercial, the consumer is motivated to visit a URL, call a toll-free telephone number, or otherwise access additional information associated with HELOC-based credit cards or other personal finance opportunities. By way of example, without limitation, such information sources may include a telephone number through which the consumer can obtain additional information about HELOC-based credit cards and sign up for such a card, and an Internet address that can be visited using a traditional web browser or other computer software running on computer 140. These information sources are collectively referred to herein as URL's for clarity. Although illustrated as a desktop computer, it should be apparent that alternative computing devices, including, without limitation, laptop computers, personal digital assistants (“PDA's”), cellular telephones, pagers, and the like may be substituted for computer 140 without departing from the spirit or the scope of the disclosed music promotion system and methods.

When the consumer accesses the URL via computer 140, computer 140 may contact a server at central office 160 via Internet 150. Although illustrated as using a public network such as the Internet, it should be apparent that one or more private networks may be substituted for Internet 150 without departing from the spirit or the scope of the invention. Such a server may utilize a browser running on computer 140 to display a series of questions to the consumer, thereby determining whether the consumer is a good candidate for HELOC-based credit cards, and/or whether other financing options might be available to and/or advisable for the consumer.

The consumer may also utilize a telephone to obtain information from central office 160. In such an embodiment, the consumer can speak with a pre-qualification specialist or the like to determine whether the consumer can take advantage of HELOC-based credit cards, or whether alternative financing options are better suited for the consumer.

In an embodiment, the consumer can utilize computer 140 to review information about the HELOC-based credit card, including any terms and conditions related thereto, and authorize the central office to open an appropriate account. Such authorization may be performed by the user providing a “digital signature” or other personally-identifiable information to the central office. In an embodiment, central office 160 then mails (represented by mailbox 170) credit cards associated with the HELOC to the consumer.

In an alternative embodiment, the consumer may speak with one or more loan officers or other professionals at central office 160 over a telephone or other voice-enabled connection, and thereby both pre-qualify for the HELOC and ensure that the formalities associated with creating the HELOC have been properly completed. The professional at central office 160 may also review the terms and conditions of the HELOC with the consumer, and record the consumer's verbal authorization to proceed. If the terms and conditions are acceptable, central office can mail credit cards associated with the HELOC to the consumer. In an embodiment, central office 160 may mail or electronically transfer a copy of the terms and conditions to the consumer prior to opening a HELOC, and may require that the consumer physically sign the documentation and return such signed documentation to the central office before the HELOC will be opened.

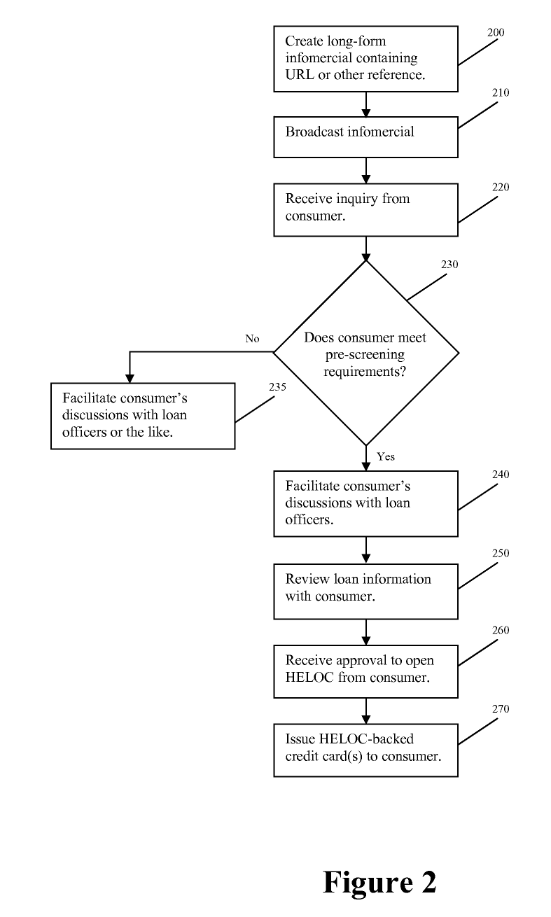

FIG. 2 is a flow diagram illustrating a method through which a consumer can be educated about available personal finance options and through which the consumer can take advantage of such options. In block 200, a long-form infomercial is created. As discussed above, it generally takes at least fifteen minutes to provide consumers with the background necessary to appreciate the advantages of certain personal finance options, such as HELOC-backed credit cards. Thus, long-form infomercials of approximately fifteen minutes or longer in duration can be created which provide such information in a format helpful to consumers.

In block 210, the infomercial is broadcast and the consumer is able to view the information contained therein. If the consumer is interested in learning more, or if the consumer is interested in participating in the personal finance opportunity presented in the infomercial, the consumer can do so by visiting a web site, calling a telephone number, or the like. Telephone communications have the advantage of being relatively secure, in that they are communications between the parties involved in the call, but are generally not open to others. Thus, consumers are generally comfortable providing private information, such as credit card numbers, social security numbers, dates of birth, and the like over the telephone. By contrast, the Internet operates using technology that is less secure. However, techniques such as Secure Socket Layer (“SSL”), virtual private networks (“VPN”) and the like exist though which Internet-based communications can be made significantly more secure. In an embodiment, any time private information is to be exchanged between a consumer and a web site or other Internet-based information service as part of the instant system, such security techniques can be employed to help protect the consumer's privacy.

In Block 220, the consumer has decided to take advantage of the personal finance opportunity presented by the instant system, and undergoes a pre-screening (Block 230). By way of example, without limitation, where the personal finance opportunity is a HELOC-based credit card, the pre-screening may confirm the consumer's identity, and confirm that the consumer owns at least one home. If the consumer does not meet the pre-screening requirements, the consumer may be connected to a loan officer, financial planner, or other professional or para-professional to discuss other personal finance opportunities that may be available to the consumer (Block 235). If the consumer does meet the pre-screening requirements, the consumer may be connected to a loan officer or other professional or para-professional to provide the information necessary to set up the HELOC (Block 240). In an embodiment, once the necessary information has been obtained from the consumer, the consumer is given the opportunity to review the terms and conditions for the HELOC (Block 250). Such an opportunity can be provided in a variety of manners, including, without limitation, by having a loan officer or other person review the terms and conditions over the telephone; providing an electronic copy of the terms and conditions to the user, such as via a secure web page or an E-mail attachment; and/or by mailing a copy of the HELOC documentation to the consumer.

Once the consumer has had an opportunity to review the terms and conditions, the consumer approves opening the HELOC (Block 260). Such approval can occur through a variety of means including, without limitation, by providing verbal approval, digitally or electronically signing a statement that the HELOC can be opened, and/or by mailing a signed copy of the HELOC documentation to a loan officer or other such person. After the approval has been received and processed, the HELOC is opened, and one or more credit cards tied to the HELOC can be issued to the consumer.

The system and methods described herein facilitate educating and informing the public about various personal finance issues and assisting the public with taking advantage of opportunities that may be advantageous for them. While detailed and specific embodiments of the instant system and methods have been described herein, it will be apparent to those skilled in the art that various changes and modifications can be made therein without departing from the spirit and scope of the instant system and methods. Thus, it is intended that the present disclosure cover these modifications and variations provided they come within the scope of any appended claims and/or their equivalents.

1. A method of educating consumers about an available personal finance option, comprising:
creating an infomercial, wherein the infomercial describes the personal finance option;
making the infomercial available to at least one consumer;
receiving an inquiry from the at least one consumer;
initiating a pre-screening based on the inquiry to determine whether the consumer can take advantage of the personal finance option;
permitting the at least one consumer to review information about the personal finance option;
receiving approval from the at least one consumer to configure an account; and,
configuring the account for the at least one consumer.

2. The method of claim 1, wherein configuring the account for the at least one consumer comprises:
opening a HELOC for the at least one consumer; and
issuing at least one credit card to the at least one consumer, wherein the at least one credit card is tied to the HELOC.

3. The method of claim 2, further comprising altering an interest rate for the at least one credit card based on an amount financed on the at least one credit card on a monthly basis.

4. The method of claim 2, further comprising altering an interest rate for the at least one credit card based on an average monthly amount financed on the at least one credit card.

5. The method of claim 1, wherein the infomercial is a long-form infomercial.

6. The method of claim 3, wherein the long-form infomercial is at least fifteen minutes long.

7. The method of claim 1, wherein the infomercial comprises information about the advantages of a HELOC-based credit card.

8. A system for providing consumers with access to an available personal finance option, comprising:
an infomercial;
a home equity line of credit; and
at least one credit card tied to the home equity line of credit;
wherein the infomercial educates consumers about the advantages of having a credit card that is tied to a home equity line of credit.

9. The system of claim 8, wherein the infomercial is a long-form infomercial.

10. The system of claim 8, wherein at least one interest rate is associated with the at least one credit card.

11. The system of claim 10, wherein the interest rate varies based on an amount purchased via the at least one card.

12. The system of claim 11, wherein the amount financed on the at least one card comprises a rolling average of the monthly amount purchased via the at least one card.

13. The system of claim 10, wherein the at least one credit card comprises a plurality of credit cards.

14. The system of claim 13, wherein the interest rate associated with each of the plurality of credit cards varies independently.
